(19) United States
(12) Patent Application Publication
(10) Pub. No.: US 2015/0186915 A1
(43) Pub. Date: Jul. 2, 2015

(54) LOYALTY PROGRAM MANAGEMENT SYSTEM

(71) Applicants: Dennis STECKLER, Lowell, MI (US); Jonathan KALMAN, Haverford, PA (US); Jim JANAVICH, Linfield, PA (US); Michele MAURER-WILLIFORD, Pinehurst, NC (US); Timothy MYERS, Malvern, PA (US); Jim ANDERESON, West Chester, PA (US)

(72) Inventors: Dennis STECKLER, Lowell, MI (US); Jonathan KALMAN, Haverford, PA (US); Jim JANAVICH, Linfield, PA (US); Michele MAURER-WILLIFORD, Pinehurst, NC (US); Timothy MYERS, Malvern, PA (US); Jim ANDERESON, West Chester, PA (US)

(21) Appl. No.: 14/489,254

(22) Filed: Sep. 17, 2014

Related U.S. Application Data
(60) Provisional application No. 61/879,057, filed on Sep. 17, 2013.

(51) Int. Cl. G06Q 30/02

(52) U.S. Cl. CPC G06Q 30/0226

(57) ABSTRACT

Systems, methods, and computer-readable media for managing a customer loyalty process are described. Some embodiments provide a customer loyalty management system for providing, controlling, implementing, or otherwise managing a customer loyalty process for customers of an entity. Illustrative entities may include, without limitation, insurance providers, banking and other financial institutions, retailers, content providers, automobile manufacturers, or the like. The management system may be configured to provide loyalty points to customers based on customer information, such as customer interactions, customer metrics, and historical information. The loyalty points may be redeemed by the customers, for example, across a plurality of products used and/or being offered to the customer. Some embodiments may be configured to increase horizontal subscription services via a cross-policy loyalty program.

### CROSS REFERENCE TO RELATED APPLICATIONS

This application claims the benefit of U.S. Provisional Application No. 61/879,057 filed on Sep. 17, 2013, the contents of which are incorporated by reference in their entirety as if fully set forth herein.

### BACKGROUND

In order to better serve customers and expand revenue potential, retailers and service providers are increasing their ability to offer “one-stop-shopping.” For example, a bank may provide a multiple horizontal services, such as checking accounts, savings accounts, investment accounts, credit card accounts, and mortgage services. The bank may also market themselves to customers and institutional clients as a single market from which customers may subscribe to several services and take advantage of all of the bank's resources, allowing the customer to obtain multiple banking and financial needs from a single provider (i.e., one-stop-shopping). It is more convenient and efficient for a banking customer to have a single destination when handling many of its financial assets. In addition, customers find synergies and conveniences in the ability to view and act on account information for all of their accounts in single location. For instance, a customer with a checking account at one bank is able to more easily transfer money to an investment account managed by the same bank than to another bank. In another instance, a customer can easily pay a credit card bill on a credit account issued by the same bank where the customer has a checking or savings account.

Insurance providers also have the ability to offer horizontal service suites. For example, insurance providers may offer other services in addition to traditional insurance products such as banking services, credit services, and investment accounts. Conventional insurance provider generally offer a suite of insurance products and services, including vehicle insurance, home insurance, personal property insurance, commercial lines of insurance, life insurance, health insurance. In addition, a “one-stop-shop” insurance provide may also offer financial products, including annuities, credit and credit card services, and various investment accounts. A subscriber can access all of their insurance products and financial services through a single provider. These service suites may provide a singular view of a customer's assets and can convey a more complete and easy-to-view portrait of the customers assets and policies.

With increased competition from banks, insurers, and other service providers, it is paramount for such providers to maintain the loyalty of customers in order to increase the number of products used by the customer and to upgrade or up-sell provider offerings to customers. As such, providers would benefit from a system that allows them to analyze and efficiently influence customer loyalty to the provider and its services and products.

### SUMMARY

This disclosure is not limited to the particular systems, devices and methods described, as these may vary. The terminology used in the description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

In an embodiment, a customer loyalty management system for a plurality of subscribers of an entity may include a processor and a non-transitory, computer-readable storage medium in operable communication with the processor. The computer-readable storage medium may contain one or more programming instructions that, when executed, cause the processor to access at least one entity system, the at least one entity system comprising a plurality of subscriber profiles for the plurality of subscribers, each subscriber profile comprising subscriber information and subscriber portfolio information, receive subscriber metrics information associated with the plurality of subscriber profiles, the subscriber metrics information generated via at least one client logic device configured to monitor at least one aspect of the subscribers, generate subscriber relationship information based on the plurality of subscriber profiles and subscriber interactions with the at least one insurance provider system, and analyze the subscriber relationship information and the subscriber metrics information using at least one loyalty rule to generate loyalty points for the subscribers, the loyalty points being configured to reward the subscribers based on customer loyalty to the entity.

In one aspect, the entity may be an insurance provider. In another aspect, the entity may be a financial institution, a retailer, a restaurant, a manufacturer, or the like.

In one aspect, the computer-readable storage medium contains one or more programming instructions that, when executed, further cause the processor to generate a predictive performance indicator for the subscribers. In another aspect, the computer-readable storage medium contains one or more programming instructions that, when executed, further cause the processor to generate a customer lifetime value based on the predictive performance indicator.

In some embodiments, subscriber metrics may include at least one aspect of the subscribers such as driving habits, home alarm activation, fire alarm activation, physical activity, and geographic location. In some embodiments, the subscriber interactions may include subscriber use of entity products or services, correspondence, web-based interactions, and feedback. In an aspect, the subscriber relationship information may be configured to indicate the loyalty strength of the relationship between the subscriber and the entity. In another aspect, generating subscriber relationship information may include weighting the subscriber interactions. In a further aspect, the computer-readable storage medium contains one or more programming instructions that, when executed, may further cause the processor to process a subscriber loyalty points redemption request across a plurality of entity products.

In an embodiment, a computer-readable storage medium having computer-readable program code configured to manage customer loyalty embodied therewith may include computer-readable program code configured to access at least one entity system, the at least one entity system comprising a plurality of subscriber profiles for the plurality of subscribers, each subscriber profile comprising subscriber information and subscriber portfolio information, computer-readable program code configured to receive subscriber metrics information associated with the plurality of subscriber profiles, the subscriber metrics information generated via at least one client logic device configured to monitor at least one aspect of the subscribers, computer-readable program code configured to generate subscriber relationship information based on the plurality of subscriber profiles and subscriber interactions with the at least one insurance provider system, and computer-readable program code configured to analyze the subscriber relationship information and the subscriber metrics information using at least one loyalty rule to generate loyalty points for the subscribers, the loyalty points being configured to reward the subscribers based on customer loyalty to the entity.

### BRIEF DESCRIPTION OF THE DRAWINGS

The above and other objects of the present invention will become more readily apparent from the following detailed description taken in connection with the accompanying drawings.

FIG. 1 depicts an illustrative customer loyalty management system according to a first embodiment.

FIG. 2 depicts an illustrative healthcare management system according to a second embodiment.

FIG. 3 depicts an illustrative management system architecture for an insurance provider according to a first embodiment.

FIG. 4A depicts a system level architecture for an illustrative management system for an insurance provider according to a second embodiment.

FIG. 4B depicts a process level architecture for an illustrative management system for an insurance provider according to the second embodiment.

FIG. 5 depicts a flow diagram for an illustrative customer loyalty program process according to some embodiments.

FIG. 6 illustrates various embodiments of a computing device for implementing the various methods and processes described herein.

### DETAILED DESCRIPTION

The present disclosure generally relates to technology for managing a customer loyalty process. In particular, some embodiments provide a customer loyalty management system (the “management system” or the “system”) for providing, controlling, implementing, or otherwise managing a customer loyalty process for customers of an entity. Illustrative entities may include, without limitation, insurance providers, banking and other financial institutions, retailers, content providers, automobile manufacturers, or the like. Some embodiments include methods, systems, and/or computer-readable media that allow a service provider (e.g., an insurance carrier) to offer a customer (e.g., a subscriber) a suite of products and to provide the customer with incentives (e.g., loyalty points) based on selected criteria relating to the loyalty and/or interactions of the customer that relate to the service provider. The incentives or loyalty points may be redeemed using various methods and across a plurality of products used and/or being offered to the customer. Some embodiments may be configured to increase horizontal subscription services via a cross-policy loyalty program.

In some embodiments, the customer loyalty process may be configured as a policyholder loyalty program (“PLP”) which may operate as a service provider (e.g. insurance) industry technology solution built on a Client Relationship Management (CRM) platform utilizing a horizontal loyalty program. In some embodiments, the PLP may be configured as a program for an insurance provider entity. Although an insurance provider is used as an example herein, embodiments are not so limited as any other type of entity capable of operating according to some embodiments is contemplated herein. Illustrative entities may include, without limitation, insurance providers, banking and other financial institutions, retailers, content providers, automobile manufacturers, or the like.

The PLP may include an insurance customer-centric rewards program that enables a customer to accumulate PLP “points” (or “loyalty points”) and levels of participation (for example, silver, gold, platinum, and diamond levels) and redemption of insurance-related purchases and/or non-insurance-related purchases. The PLP may be configured to facilitate and increase long-term policyholder loyalty with the insurance provider, improving policyholder retention, an industry-wide key performance indicator (“KPI”). The PLP may extend to a plurality of insurance products purchased or otherwise associated with a subscriber and is not limited to a single product or line of business. In some embodiments, the PLP may track subscriber activity and report the results to the subscriber and/or insurance provider through multi-channel access points (e.g., mobile computing devices, personal computers, or other client logic devices.)

The PLP may use telematics devices and processes for vehicle coverage products to measure driving behavior that can generate points in combination with other line-of-business (LOB) products purchased by the products. In some embodiments, the PLP may use the telematics information to determine subscriber loyalty information and not to determine policyholder rating. The PLP may be configured to facilitate an insurance company to offer an insurance subscriber a total customer account underwriting and rating (“account-based”) model to develop pricing and coverage based on the whole customer relationship.

The management system described according to some embodiments provides multiple technological advantages and technical effects on processes and techniques, including processes and techniques external to the management system. Using conventional customer loyalty processes, customer loyalty programs have been primarily an inefficient and inaccurate process. For example, conventional loyalty processes often inaccurately reward customers based on factors that do not benefit the customer and/or the entity (i.e., increase customer loyalty, increase customer use of services or add new services). One non-limiting technological advantage and technical effect of the management system according to some embodiments is that the management system may allow an entity to recognize factors that affect customer loyalty in a manner that is more efficient than current customer loyalty processes, including techniques carried out by an individual without the use of a computing device or other management system technology. Another non-limiting technological advantage and technical effect of the management system according to some embodiments is that the management system may allow an entity to determine what factors are most effectively related to customer loyalty and/or to increasing customer loyalty in a manner that is more efficient than current processes. A further non-limiting technological advantage and technical effect of the management system according to some embodiments is that the management system may allow certain devices, such as computing devices, to operate more effectively and efficiently when being used to manage a customer loyalty program in a manner that is more proficient than current processes. Accordingly, the management system according to some embodiments may operate to improve the customer loyalty process by making the process more efficient, accurate, and cost-effective and may improve the user experience of customers interacting with entities, their products and services, and interfaces therewith.

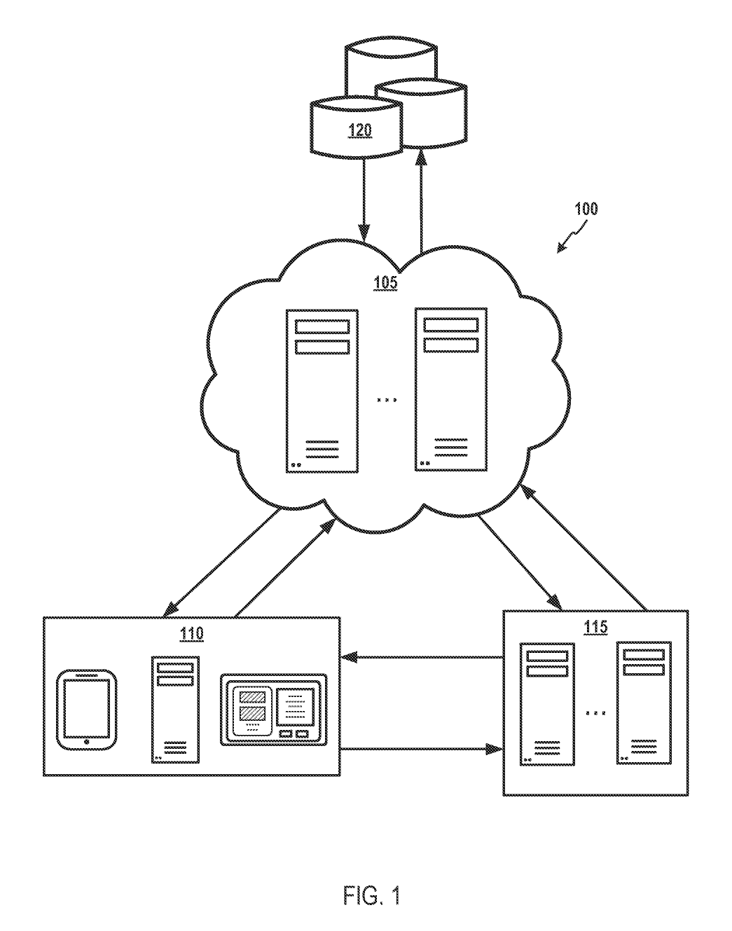

FIG. 1 depicts an illustrative customer loyalty management system according to a first embodiment. As shown in FIG. 1, the customer loyalty management system (the “management system” or the “system”) 100 may include one or more server logic devices 110, which may generally include a processor, a non-transitory memory or other storage device for housing programming instructions, data or information regarding one or more applications, and other hardware, including, for example, the central processing unit (CPU) 505, read only memory (ROM) 510, random access memory (RAM) 515, communication ports 540, controller 520, and/or memory device 525 depicted in FIG. 75 and described below in reference thereto.

In some embodiments, the programming instructions may include a customer loyalty management application (the “management application” or the “application”) configured to, among other things, access entity information (e.g., product information, loyalty program information, or the like), analyze customer (or “subscriber”) information, receive subscriber metrics, generate subscriber relationship information, and generate loyalty points. The server logic devices 110 may be in operable communication with an entity system 115. The entity system 115 may include an operational (or “corporate”) system used by an entity in the course of business, including for storing entity data, executing entity applications, and performing entity applications. A non-limiting example of an entity system 115 is an insurance provider system that may include, but is not limited to, data storage devices and/or databases configured to store product information, subscriber information, insurance provider applications and user interfaces, and any other information and/or applications that may be utilized in the operations of the insurance provider.

The management system 100 may connect with the entity system 115 through one or more integration points that may include security permissions and data transfer interfaces. In some embodiments, the management system 100 and/or management application may be configured to interface with the entity system 115 such that the entity system 115 does not have to be modified to allow an entity to use the management system 100 to manage a customer loyalty system. The management system 100 may interface with the entity system 115 such that the management system may access and use information of the entity system to manage a customer loyalty system, such as entity products, services, third-party providers (i.e., entity partners), and subscriber information.

The server logic devices 110 may be in operable communication with client logic devices 105, including, but not limited to, server computing devices, personal computers (PCs), kiosk computing devices, mobile computing devices, laptop computers, smartphones, personal digital assistants (PDAs), medical equipment, tablet computing devices, telematics, or any other logic and/or computing devices now known or developed in the future. In some embodiments, the client logic devices 105 may be owned, operated, or otherwise associated with entity subscribers and/or the entity itself (i.e., entity servers, employee logic devices, customer access points, etc.).

In some embodiments, the management application may be accessible through various platforms, such as a client application, web-based application, over the Internet, and/or a mobile application (for example, a “mobile app” or “app”). According to some embodiments, the management application may be configured to operate on each client logic device 105 and/or to operate on a server computing device accessible to client logic devices over a network, such as the Internet. All or some of the files, data and/or processes used for management of a customer loyalty process may be stored locally on each client logic device 105 and/or stored in a central location and accessible over a network (e.g., the Internet or on server logic devices 110).

In an embodiment, one or more data stores 115 may be accessible by the client logic devices 105 and/or server logic devices 110. The data stores 115 may include information use for the management of a customer loyalty process, such as subscriber information, demographic information, entity information, competitor information, industry information, third-party information, or the like. Although the one or more data stores 115 are depicted as being separate from the logic devices 105, 110, embodiments are not so limited, as all or some of the one or more data stores may be stored in one or more of the logic devices.

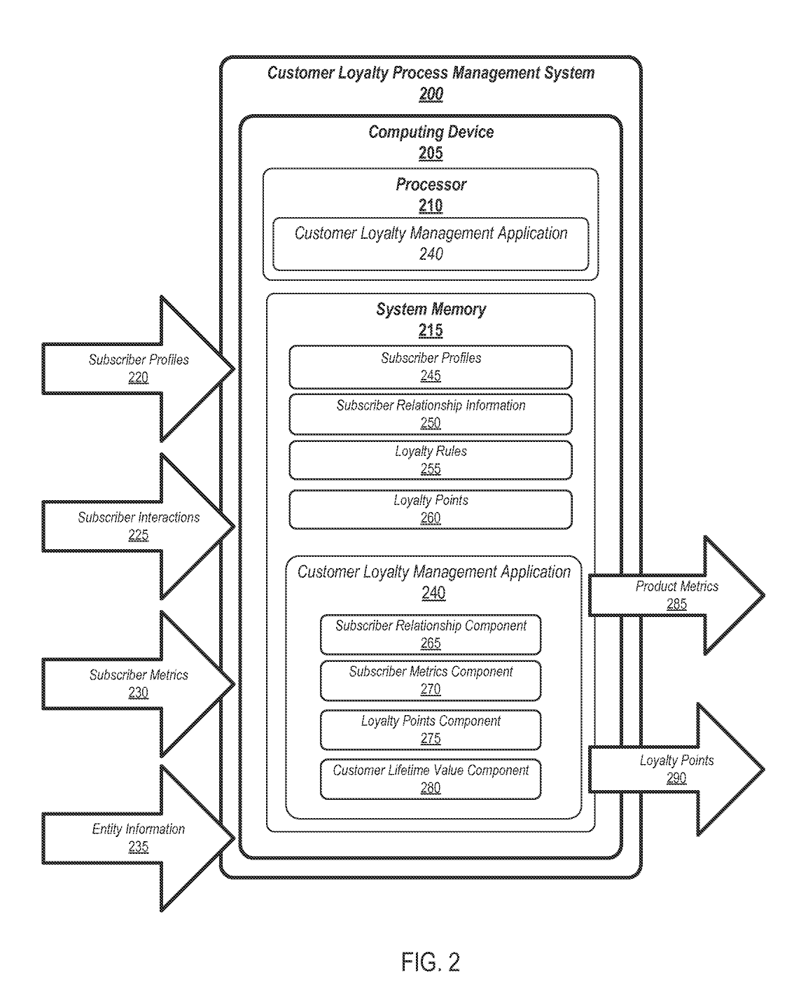

FIG. 2 depicts an illustrative healthcare management system according to a second embodiment. As shown in FIG. 2, a customer loyalty process management system (the “management system”) 200 may include a computing device 205 having a processor 210 and system memory 215. The computing device 205 may include any type of computing device, such as the client logic device 105 and server logic devices 110 described in reference to FIG. 1. The processor 210 may be configured to execute a customer loyalty management application (the “management application”) 240. The management application 240 may be configured to receive subscriber profiles 220, subscriber interactions 225, and/or subscriber metrics 240.

The subscriber profiles 220 may include information associated with an entity subscriber and/or their property, including subscriber information and subscriber portfolio information. The subscriber information may include any information associated with a subscriber, such as demographic information and any historical information maintained by the entity, such as historical payment information, interaction information, portfolio information, or the like. The subscriber portfolio information may include information associated with the products and services being provided to the subscriber by the entity. For instance, for an insurance provider entity, the subscriber portfolio may include the insurance products being provided by the insurance provider to the subscriber and any information relating thereto, such as insurance policy details. For an automobile manufacturer, the subscriber portfolio may include any products or services being provided to a purchaser, such as an extended warranty or automobile service plan.

Subscriber interactions 225 may include any interactions from the subscriber to the entity, and vice versa. Such interactions may include information pertaining to the use of products and/or services, correspondences (e.g., emails, phone calls, etc.), web-based interactions (e.g., logging into entity systems, message posts, browsing activity, purchases, accessing articles or other entity information, etc.), claims, feedback, or the like.

In some embodiments, client logic devices 105 may be configured to provide subscriber metrics 230 pertaining to a subscriber to the management application 230. The subscriber metrics 230 may include any data associated with the activity of a subscriber or their property. Non-limiting examples of subscriber metrics 230 may include data from a telematics device, user-based insurance (UBI) information, an alarm system (such as a home or automobile alarm system), a home heating/cooling system device (i.e., Nest® by Nest Labs, Inc. of Palo Alto, California, United States), global positioning system (GPS), a fire alarm, a carbon monoxide detector, an automobile communication system (e.g., OnStar® by OnStar, LLC of Detroit, Mich., United States), physical activity devices (e.g., Nike+FuelBand® by Nike of Beaverton, Oreg., United States), healthcare information (e.g., blood pressure monitor, pulse oximetry device, blood sugar measuring device, or the like.), client logic devices 105 (e.g., from applications operating on a client logic device), or the like.

The entity information 235 may include any information relating to the entity and/or the customer loyalty process of the entity, such as products and product information, subscriber data (e.g., information associated with their subscriber population, such as number and/or types of products per subscriber, average subscriber spend, etc.), loyalty program information (e.g., reward structure, goals, etc. of the customer loyalty process), or the like. Illustrative products for an insurance provider may include automotive insurance, life insurance, homeowners insurance, property and casualty, life, annuity, and health vertical products, banking products, and strategic third-party products.

The management application 240 may include various modules, programs, applications, routines, functions, processes, or the like (“components”) to perform functions according to some embodiments described herein. In some embodiments, the management application 240 may include a subscriber relationship component 265, a subscriber metrics component 270, a loyalty points component 265, and/or a customer lifetime value component 275. In some embodiments, the components 265-280 may be configured to access and/or generate subscriber profiles 245, subscriber relationship information 235, loyalty rules 255, and/or loyalty points 260 stored in the system memory 215. The components 265-280 may be configured to generate insurance product metrics 285 and/or loyalty points 290.

The subscriber relationship component 265 may be configured to determine a relationship and/or aspects of a relationship between a subscriber and the entity and/or entity products. The subscriber relationship component 265 may analyze the subscriber profiles 220 and one or both of the subscriber interactions 225 and the subscriber metrics to determine a relationship between a subscriber and the entity and/or entity products. The subscriber relationship may be stored as subscriber relationship information 250. In some embodiments, the subscriber relationship may be configured to determine the nature and type (e.g., the “loyalty strength”) of the relationship between the subscriber and the entity and/or entity products. In some embodiments, the subscriber relationship may be configured to determine a level of loyalty between the subscriber and the entity and/or entity products. For instance, the subscriber relationship component 265 may analyze the type, number, and nature of the subscriber interactions 225 of a particular subscriber to determine the relationship (e.g., how “loyal” is the subscriber). In some embodiments, the subscriber relationship component 265 may categorize, score, rank, or otherwise provide a value (a “subscriber relationship value”) for a subscriber. The loyalty value may be configured to indicate how loyal a subscriber is to the entity.

The subscriber relationship component 265 may be configured to align with the interests and/or goals of an entity. For example, a first entity may place more value on the number of interactions between a subscriber and the entity (e.g., how often does the subscriber log into their entity account). A second entity may place more value on the nature of each interaction, such as whether the subscriber browses new products or subscribes to entity product emails. The subscriber relationship component 265 may be configured to compile, categorize, analyze, and/or weight subscriber interactions 225 according to entity preferences.

The subscriber metrics component 270 may be configured to compile and analyze subscriber metrics 230. In some embodiments, the subscriber metrics component 270 may be configured to categorize, score, rank, or otherwise provide a value (a “subscriber metrics value”) for the subscriber metrics 230. In some embodiments, the subscriber metrics component 270 may communicate the subscriber metrics value to the subscriber relationship component 265, which may use the subscriber metrics value to determine the subscriber relationship information 250.

The loyalty points component 275 may be configured to generate loyalty points for each subscriber according to an entity customer loyalty process. In some embodiments, the loyalty points component 275 may be configured to analyze the subscriber relationship information 250, the subscriber metrics 230, and/or other information using at least one loyalty rule 255 to generate loyalty points 290 for the subscribers. The loyalty points 290 may be stored as loyalty points 260 in the main memory 215. The loyalty rules 255 may include any rules, calculations, algorithms, routines, weights, factors, or processes that may be used to determine loyalty points 290 from the subscriber relationship information 250, the subscriber metrics 230, and/or other information. For example, the loyalty rules 255 may provide weights for different entity products, such as more weight for a multi-car automobile insurance policy over a single homeowner policy. In another example, the loyalty rules 255 may specify the value to assign to the longevity of a subscriber or if the subscriber has products through a competitor (for instance, a home equity line of credit with a competitor bank). The subscriber may redeem the loyalty points 290 as provided by the entity, such as lower rates, discounts, third-party partners, merchandise, increased access or service, or the like.

In some embodiments, the management application 240 may use various information sources, such as the subscriber profiles 220, subscriber interactions 225, subscriber metrics 230, and/or entity information 235 to generate product metrics 285. The product metrics 285 may be configured to provide information about the subscriber interactions with and/or use of entity products. For instance, the product metrics 285 may allow an entity to receive information and/or graphically visualize how subscribers shop for, purchase, use, upgrade/downgrade, and/or the like their products. In some embodiments, the product metrics 285 may be generated and/or presented in terms of loyalty points 260. For example, the product metrics 285 may be configured to indicate which subscribers used their loyalty points and, in addition, which subscribers used their loyalty points with entity products versus those that used their loyalty points for external products or services.

In some embodiments, a portion of the product metrics 285 may be provided to a subscriber, including the loyalty points 290 associated with the subscriber. In this manner, a subscriber may visualize their interactions with the entity and/or entity products and their loyalty points 290 and may interact with the entity and/or entity products accordingly (e.g., to increase loyalty points).

The customer lifetime value component 280 may be configured to generate predictions relating to subscribers and/or classes of subscribers (e.g., based on demographic categories, products, or the like), such as predictive performance indicators (PPI). The PPI may be generated based on an analysis of various forms of information, including, subscriber profiles, the subscriber interactions, the subscriber metrics 230, the entity information 235, the subscriber loyalty information 250, industry information, or the like. The customer lifetime value component 280 may use the PPI to determine a customer lifetime value (CLV) for the subscriber. The CLV may be configured to indicate the profitability of the subscribers. The loyalty points component 275 may use the PPI and CLV in determining how and to which subscribers to award loyalty points. In some embodiments, the loyalty points may be determined and awarded based on the PPI and CLV to maximize future profitability outcomes for the entity.

In an embodiment, the management system, such as through the components 265-280, may include various other modules (“core modules”) (not shown), such as a program management module, a reward-rule management module, a membership handling module, and a processing engine module. Each module may directly address individual, loyalty-specific business processes described herein. Such an embodiment may be implemented with analysis, integration, and collaboration phases overlapping the core modules. Initial analysis may include program creation, program design and setup, program partner maintenance, and dynamic attribute maintenance. The design and setup may further include a program management module that includes a CRM component and a loyalty component. The program design may also include a reward rules management module to govern the details of the attribution and distribution of reward benefits to a policyholder. The integration phase may involve program execution via the membership handling module and the processing engine module. The integration, collaboration and analysis phases may be configured to capture, among other things, sales, web-based channels, and other connectivity forums.

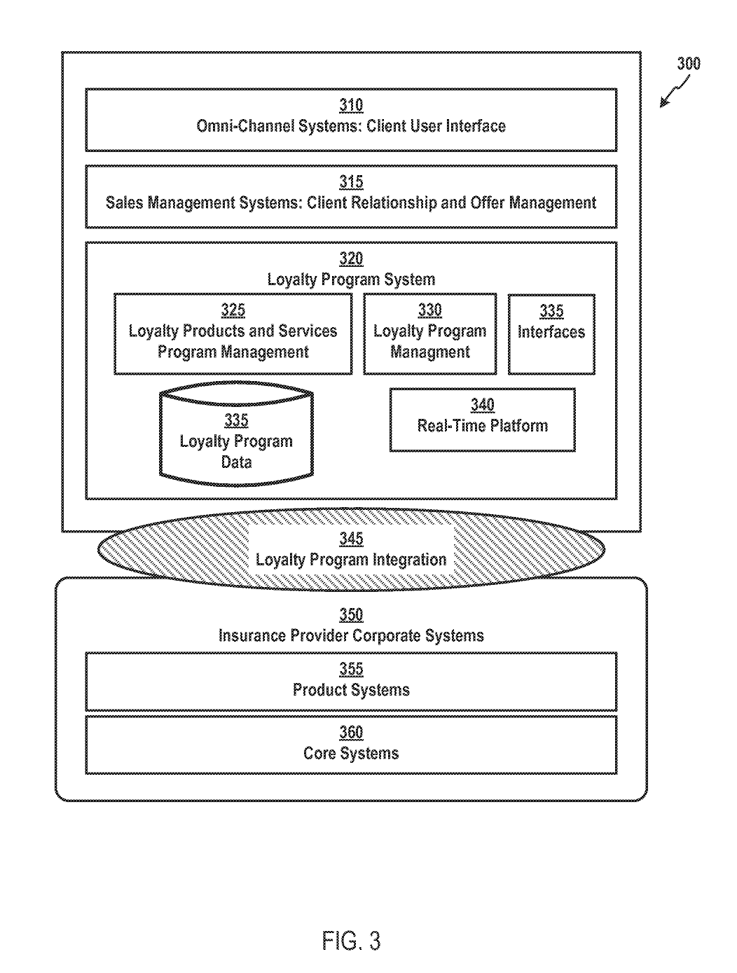

FIG. 3 depicts an illustrative management system architecture for an insurance provider according to a first embodiment. As shown in FIG. 3, a management system 300 may include omni-channel system 310 that may provide client access interfaces, such as a customer portal, an entity homepage, mobile access (e.g., through entity mobile applications), business analytics, or the like. The omni-channel system 310 may provide access through a variety of channels and services, including Internet, social media, mobile, analytics, and cloud.

A sales management system 315 may provide processes for client relationships and offer management. The sales management system 315 may include components including, without limitation, sales management, marketing, product configuration, services, buyer analytics, loyalty analytics, and account rating engines. A loyalty program system 320 may be in operable communication with a plurality of insurance provider corporate systems 350 through a loyalty program integration 345 component. The loyalty program system 320 may include various components including, but not limited to, a loyalty program management component, web services interfaces, third-party systems, core systems, a real-time, in-memory platform, and a loyalty program repository.

The insurance provider corporate systems 350 may include product systems 355 and core systems 360. The product systems 355 may include components for property and casualty products, life insurance products, health insurance products, annuity products, banking products, third-party partners, general ledger components, and legal components. The core system 360 may include policy administration components, claims components, billing components, commissions components, agent components, reinsurance components, and reporting components.

Some embodiments may provide custom and fully integrated software and systems configuration across all lines of business, banking, and strategic partners. The system 300 may use insurance providers' domain knowledge and platforms (e.g., SAP® and/or SAP® HANA by SAP of Walldorf, Baden-Wurttemberg, Germany), loyalty software, business objects, and other assets.

In some embodiments, the system 300 may generate loyalty points across all of the insurance customer's purchased insurance products (e.g., personal, commercial, life, health, and financial services lines of business) and profitability on a portfolio basis in order to facilitate long-term customer retention. As a policyholder increases his insurance relationship with the carrier, the policyholder may obtain and increase accumulated points and higher loyalty tier (e.g., Silver—Gold—Platinum—Diamond) benefits.

In some embodiments, the system 300 may begin with a standard insurance auto/motorcycle/commercial auto policy construction based on currently used actuarial algorithms and underwriting rules. In a non-limiting example, a new “Auto UBI Rewards Policy” may be constructed with the following features: (1) design an auto policy with a reduced policy rate on new and renewal policies over traditionally rated policies without usage based insurance (“UBI”) driving behavior monitoring; (2) require insured to apply for UBI membership rewards program; (3) insured receives UBI metrics updates; and (4) insured accumulates a bank of member points (e.g., weekly, monthly, etc.) and membership rewards may last the entire relationship the insured is a carrier policyholder (i.e., to facilitate retention objective). In some embodiments, the Auto UBI Rewards may be based on one or more of points increase for good driving behavior, points are lost for poor driving behavior, points can be redeemed for various reasons and decided by the policyholder, and points may be increased or decreased based on the physical condition of the car.

As described herein, some embodiments may include methods and systems that allow a service provider (e.g., an insurance carrier) to offer a customer (e.g., a subscriber) a suite of products, and provide the customer with points (e.g., loyalty points) based on selected criteria, where the points can be redeemed across two or more, and in some cases an entire range, of the products offered to the customer. In some embodiments, the loyalty points may be redeemable on services and/or products offered by third parties. The service provider can offer multiple services. For example, an insurance carrier can offer auto insurance, life insurance, disability insurance and a variety of other insurance and/or banking products to a customer. The customer can acquire loyalty points based on various rules and information (e.g., driving habits, purchased products, payment history, longevity, etc.). In a non-limiting example, a telematics systems can be used to monitor and record a customer's driving habits. If the customer's driving habits match certain preselected criteria over a given period of time, the customer can acquire a number of loyalty points. Such loyalty points can be redeemable across a range of products for which the customer has a subscription.

In an embodiment, points accrued by a subscriber (insured) can be redeemed by the subscriber on a portfolio of policies and will be accumulative across all lines of the insurance provider's business. The policyholder can also redeem points to pay for insurance related or non-related benefits regardless of the line of business. The insurance company will determine what benefits points are allowable for redemption. Examples of redeemable points applied to vehicle insurance, include, but are not limited to insurance related redemptions (e.g., vanishing deductible, reduced or satisfaction of a deductible in a claim situation, roadside assistance or towing payment, loss of use rental car assistance, reduction of points (assuming enough points accumulated), payment for an additional premium payment, and payment of or credit toward an invoice or renewal payment), entertainment redemption (e.g., special retail offerings from the carrier, third-party partnerships with the carrier, sporting events and concerts), merchandise redemption, travel redemption, or the like

While the embodiments described herein relate to the insurance industry and products offered by insurance companies, one of skill in the art will recognize that the scope of the invention is not limited to only the described industry. Other industries, in which a suite of services or products offered by an institution or company, such as the banking industry, investment industry, etc., are fully contemplated to fall within the scope of the invention.

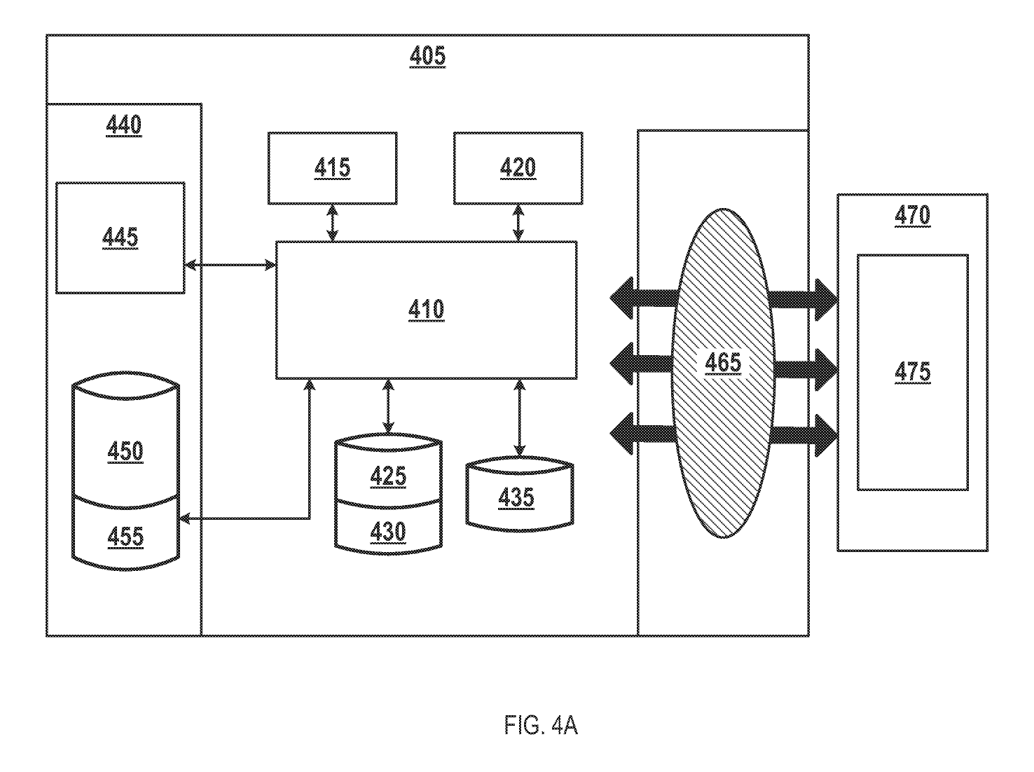

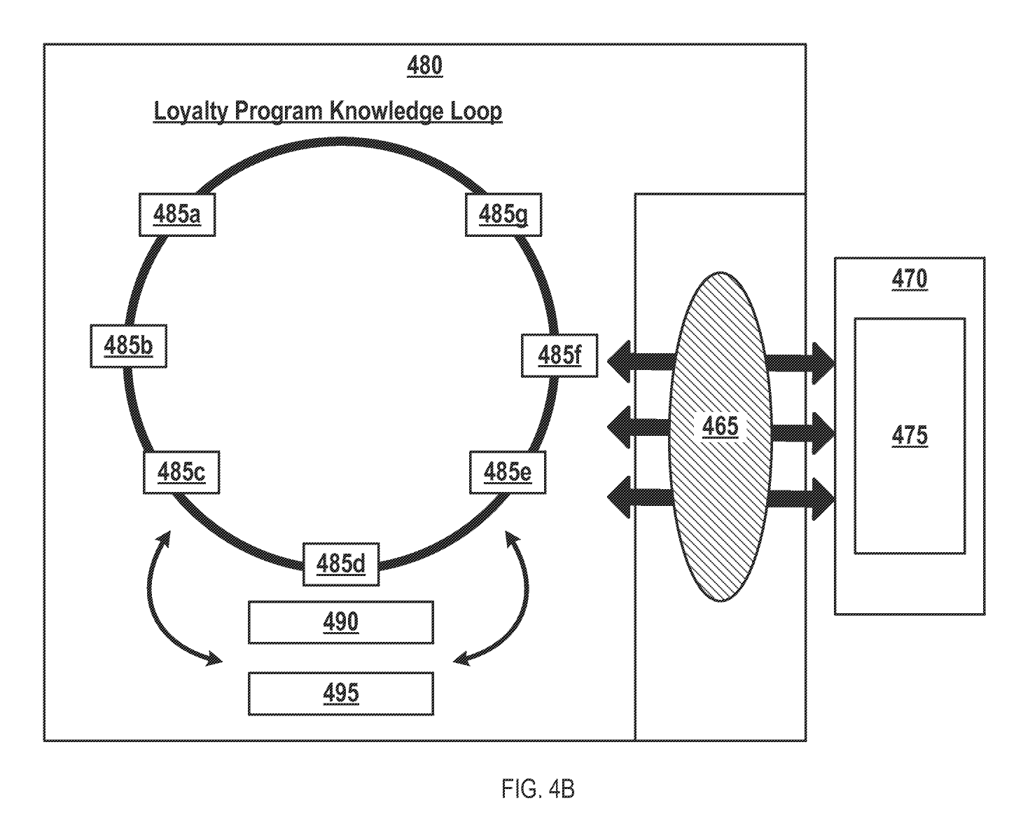

FIG. 4A depicts a system level architecture for an illustrative management system for an insurance provider according to a second embodiment. As shown in FIG. 4A, a loyalty management architecture may include various analytical processes 405, such as a loyalty management analytics component 410. A sales and marketing component 415 and a subscriber loyalty statistics component 420 may be in communication with the loyalty management analytics component 410. The loyalty management architecture 405 may include various data stores such as a loyalty campaign content database 425, a loyalty based retention statistics database 430, and a loyalty performance changes database 435. A transactional processes component 440 may include an enterprise transaction processing system 445, an enterprise data warehouse 450, and a policyholder loyalty database 455.

An omni-channel interface 465 may be used for communication between the analytical processes 405 and a policyholder 475 having various policyholder processes (e.g., wants or needs) 475 including, without limitation, insurance identification, product decisions, purchase policies, risk protection attainment, loyalty points, and policy renewal.

FIG. 4B depicts a process level architecture for an illustrative management system for an insurance provider according to the second embodiment. As shown in FIG. 4B, the process level architecture may include a loyalty program knowledge loop 480. Various processes may be included on the loyalty program knowledge loop 480 such as loyalty program scoring 485a, loyalty program profiling 485b, policyholder feedback 485c, services processes 485d, complaint resolution 485e, sales processes management 485f, and campaign management 485g. The loyalty program knowledge loop 480 may interact with data and analytics 490 in order to analyze, improve, and innovate 495 the program knowledge loop.

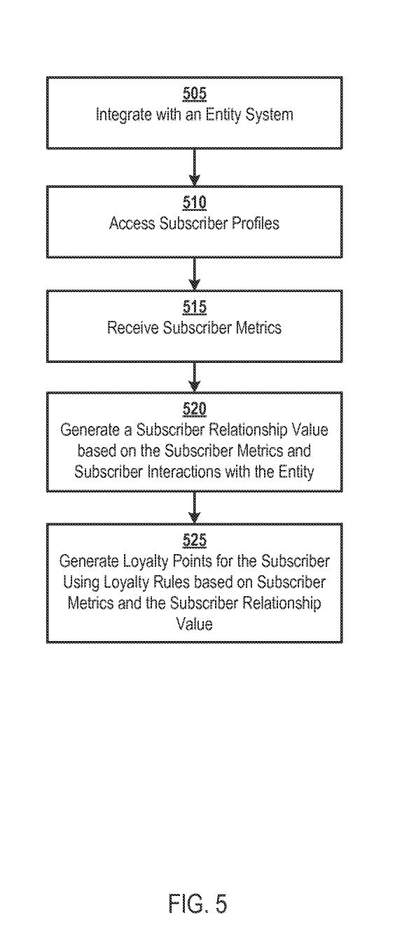

FIG. 5 depicts a flow diagram for an illustrative customer loyalty program process according to some embodiments. The method of FIG. 5 may be carried out by a management system (such as management system 200 of FIG. 2) and may include more or fewer steps than shown in FIG. 5 in the same or a different order. As shown in FIG. 5, the management system may integrate 505 with an entity system, such as an insurance provider or banking institution system. Subscriber profiles for the entity may be accessed 510. The management system may receive 515 subscriber metrics associated with the activity of the subscribers. A subscriber relationship value may be generated 520 may the management system based on the subscriber metrics and subscriber interactions with the entity. The management system may generate 525 loyalty points for the subscriber. The loyalty points may be generated 525 using loyalty rules based on the subscriber metrics and the subscriber relationship value.

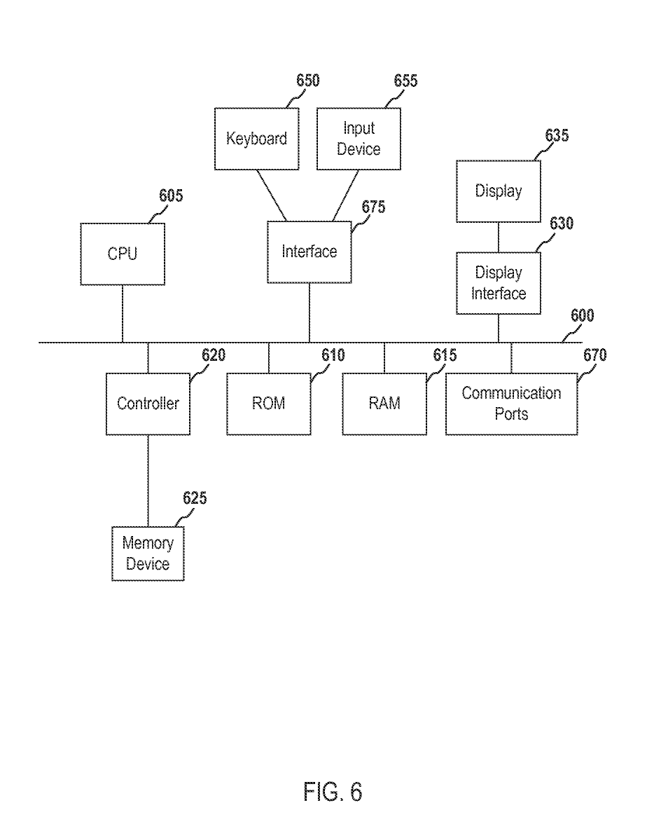

FIG. 6 depicts a block diagram of exemplary internal hardware that may be used to contain or implement the various computer processes and systems as discussed above. A bus 600 serves as the main information highway interconnecting the other illustrated components of the hardware. CPU 605 is the central processing unit of the system, performing calculations and logic operations required to execute a program. CPU 605 is an exemplary processing device, computing device or processor as such terms are used within this disclosure. Read only memory (ROM) 630 and random access memory (RAM) 635 constitute exemplary memory devices.

A controller 620 interfaces with one or more optional memory devices 625 to the system bus 600. These memory devices 625 may include, for example, an external or internal DVD drive, a CD ROM drive, a hard drive, flash memory, a USB drive or the like. As indicated previously, these various drives and controllers are optional devices. Additionally, the memory devices 625 may be configured to include individual files for storing any software modules or instructions, auxiliary data, common files for storing groups of results or auxiliary, or one or more databases for storing the result information, auxiliary data, and related information as discussed above.

Program instructions, software or interactive modules for performing any of the functional steps associated with the analysis of judicial decision making as described above may be stored in the ROM 630 and/or the RAM 635. Optionally, the program instructions may be stored on a tangible computer-readable medium such as a compact disk, a digital disk, flash memory, a memory card, a USB drive, an optical disc storage medium, such as a Blu-ray™ disc, and/or other recording medium.

An optional display interface 630 may permit information from the bus 600 to be displayed on the display 635 in audio, visual, graphic or alphanumeric format. The information may include information related to a current job ticket and associated tasks. Communication with external devices may occur using various communication ports 640. An exemplary communication port 640 may be attached to a communications network, such as the Internet or a local area network.

The hardware may also include an interface 645 which allows for receipt of data from input devices such as a keyboard 650 or other input device 655 such as a mouse, a joystick, a touch screen, a remote control, a pointing device, a video input device and/or an audio input device.

It will be appreciated that various of the above-disclosed and other features and functions, or alternatives thereof, may be desirably combined into many other different systems or applications. It will also be appreciated that various presently unforeseen or unanticipated alternatives, modifications, variations or improvements therein may be subsequently made by those skilled in the art which alternatives, variations and improvements are also intended to be encompassed by some embodiments described herein.

What is claimed is:

1. A customer loyalty management system for a plurality of subscribers of an entity, the system comprising:
a processor; and
a non-transitory, computer-readable storage medium in operable communication with the processor, wherein the computer-readable storage medium contains one or more programming instructions that, when executed, cause the processor to:
access at least one entity system, the at least one entity system comprising a plurality of subscriber profiles for the plurality of subscribers, each subscriber profile comprising subscriber information and subscriber portfolio information,
receive subscriber metrics information associated with the plurality of subscriber profiles, the subscriber metrics information generated via at least one client logic device configured to monitor at least one aspect of the subscribers,
generate subscriber relationship information based on the plurality of subscriber profiles and subscriber interactions with the at least one insurance provider system, and
analyze the subscriber relationship information and the subscriber metrics information using at least one loyalty rule to generate loyalty points for the subscribers, the loyalty points being configured to reward the subscribers based on customer loyalty to the entity.

2. The system of claim 1, wherein the entity is an insurance provider.

3. The system of claim 1, wherein the computer-readable storage medium contains one or more programming instructions that, when executed, further cause the processor to generate a predictive performance indicator for the subscribers.

4. The system of claim 3, wherein the computer-readable storage medium contains one or more programming instructions that, when executed, further cause the processor to generate a customer lifetime value based on the predictive performance indicator.

5. The system of claim 1, wherein the at least one aspect of the subscribers comprises at least one of driving habits, home alarm activation, fire alarm activation, physical activity, and geographic location.

6. The system of claim 1, wherein the subscriber interactions comprise at least one of subscriber use of entity products or services, correspondence, web-based interactions, and feedback.

7. The system of claim 1, wherein the subscriber relationship information is configured to indicate the loyalty strength of the relationship between the subscriber and the entity.

8. The system of claim 1, wherein generating subscriber relationship information comprises weighting the subscriber interactions.

9. The system of claim 1, wherein the computer-readable storage medium contains one or more programming instructions that, when executed, further cause the processor to process a subscriber loyalty points redemption request across a plurality of entity products.

10. A computer-readable storage medium having computer-readable program code configured to manage customer loyalty embodied therewith, the computer-readable program code comprising:
computer-readable program code configured to access at least one entity system, the at least one entity system comprising a plurality of subscriber profiles for the plurality of subscribers, each subscriber profile comprising subscriber information and subscriber portfolio information;
computer-readable program code configured to receive subscriber metrics information associated with the plurality of subscriber profiles, the subscriber metrics information generated via at least one client logic device configured to monitor at least one aspect of the subscribers;
computer-readable program code configured to generate subscriber relationship information based on the plurality of subscriber profiles and subscriber interactions with the at least one insurance provider system; and
computer-readable program code configured to analyze the subscriber relationship information and the subscriber metrics information using at least one loyalty rule to generate loyalty points for the subscribers, the loyalty points being configured to reward the subscribers based on customer loyalty to the entity.

11. The computer-readable storage medium of claim 10, wherein the entity is an insurance provider.

12. The computer-readable storage medium of claim 10, wherein the computer-readable program code further comprises computer-readable program code configured to generate a predictive performance indicator for the subscribers.

13. The computer-readable storage medium of claim 12, wherein the computer-readable program code further comprises computer-readable program code configured to generate a customer lifetime value based on the predictive performance indicator.

14. The computer-readable storage medium of claim 10, wherein the at least one aspect of the subscribers comprises at least one of driving habits, home alarm activation, fire alarm activation, physical activity, and geographic location.

15. The computer-readable storage medium of claim 10, wherein the subscriber interactions comprise at least one of subscriber use of entity products or services, correspondence, web-based interactions, and feedback.

16. The computer-readable storage medium of claim 10, wherein the subscriber relationship information is configured to indicate the loyalty strength of the relationship between the subscriber and the entity.

17. The computer-readable storage medium of claim 10, wherein generating subscriber relationship information comprises weighting the subscriber interactions.

18. The computer-readable storage medium of claim 10, wherein the computer-readable program code further comprises computer-readable program code configured to process a subscriber loyalty points redemption request across a plurality of entity products.
